(19) United States
(12) Patent Application Publication
(10) Pub. No.: US 2005/0072623 A1
(43) Pub. Date: Apr. 7, 2005

(54) Baffle-loaded mouthpiece

(76) Inventor: Philip L. Rovner, Timonium, MD (US)

Correspondence Address: Royal W. Craig;Law Offices of Royal W. Craig, Suite 153, 10 N. Calvert Street, Baltimore, MD, 21202, US

(21) Appl. No.: 10/941,341

(22) Filed: Sep. 15, 2004

Related U.S. Application Data
(60) Provisional application No. 60/504,849, filed on Sep. 22, 2003.

(51) Int. Cl. G01K 11/00

(52) U.S. Cl. 181/21

(57) ABSTRACT

A mouthpiece for woodwind instruments that generally comprises a body defined by a window opening at one end, a annular opening at another end, an internal tone chamber, and an internal bore, and a baffle positioned within the body at precisely the interface between the tone chamber and the bore. The body is generally cylindrical with a tapered front section that is substantially flat on one side and a tapered rear section designed to attach to a woodwind instrument in a conventional manner. The baffle is located within the body perpendicular to the longitudinal axis of the mouthpiece and serves to generate a standing-wave on an attached reed in order to improve the response, tonality, and power of an instrument. Elements of the present invention are economically fabricated of conventional materials, and are scalable and capable of being fitted to all existing woodwinds.

### CROSS-REFERENCE TO RELATED APPLICATIONS

The present application derives priority from U.S. Provisional Patent Application 60/504,849 for “BAFFLE-LOADED MOUTHPIECE”, filed Sep. 22, 2003.

### BACKGROUND OF THE INVENTION

1. Field of the Invention

The present invention relates to musical instruments and, more particularly, to woodwind instruments that utilize a reed affixed to a mouthpiece, and even more particularly, to a mouthpiece incorporating an internal baffle that generates a standing-wave on the reed resulting in an improvement in the response, tone, and power of the attached instrument.

2. Description of the Background

A vibrating reed is attached to the mouthpiece of a single-reed woodwind instrument to affect the overall sound (i.e. response, power, tonality) of the musical instrument. A typical mouthpiece consists of two internal sections; the tone chamber located proximate the attached reed, and the bore which is proximate the end where the mouthpiece attaches to an instrument. The reed, which is tapered in thickness along approximately one-half of its length, is attached over an opening in the mouthpiece, commonly known as the window, such that the reed's very flexible, tapered end functions as a valve that rapidly opens and closes the window. The window is typically positioned and sized such that approximately one-half to three-fourths of the underside of the reed, including the entire length of its tapered end, is in oscillatory cooperation with the vibrating air column in the instrument via the tone chamber of the mouthpiece.

The configuration of a mouthpiece's tone chamber and bore influence the tonal quality and playing response of the attached instrument. The tone chamber is primarily an acoustic transformer which converts the higher acoustic impedance at the tip of the mouthpiece (i.e. where the tapered end of the reed element is positioned) to a lower impedance at the chamber's interface with the bore. An endless variety of tonal colorations can be achieved by varying the geometry of the chamber and the bore. U.S. Pat. Nos. 5,303,628 to Salazar, 5,105,701 to Hall et al., and 4,449,439 to Wells disclose respective examples of these variations.

U.S. Pat. No. 5,303,628 to Salazar discloses a mouthpiece for a clarinet and saxophone to be used with a reed. The mouthpiece has a tip and a face having two spaced sides extending towards each other from the tip. The face has an opening adjacent to the tip between the sides and a longitudinal bore communicating with the opening. The face is arcuately curved downwardly toward the tip thereby forming a face gap distance between the face and the reed. A wing member extends from each of the sides away from the opening so that the mouthpiece flares outwardly at the face to direct air into the opening. The wing members extend substantially to the tip of the mouthpiece. The wing members fill triangular spaced gaps between the lips to direct air into the mouthpiece opening. The mouthpiece improves the tonal qualities of the instrument and requires less effort than with conventional mouthpieces.

U.S. Pat. No. 5,105,701 to Hall et al. discloses a mouthpiece for a clarinet wherein the facing over which the reed is attached and which extends around the opening in the mouthpiece is uniquely curved to vary the gap between the reed and the facing and wherein the bore is provided with a tapered A-frame bridge adjacent the sound baffle of the mouthpiece.

U.S. Pat. No. 4,449,439 to Wells discloses an improved mouthpiece intended for woodwind instruments such as clarinets and saxophones that includes a key-shaped slotted cut-out section formed along the horizontally flattened portion thereof. The key-shaped, slotted cut-out section is formed by a pair of opposed curvilinear flanges formed along the opposed side edges of the slotted cut-out section, the curvilinear flanges having a sufficient thickness such as to reduce the overall diameter of the wind channel by between 25% and 50%, thereby creating a wind compression chamber adjacent to the tip end of the mouthpiece along the path of the wind channel to smooth out the vibrational air pulses that travel through the mouthpiece and into the instrument. The mouthpiece improves the tonal qualities of the instrument throughout its entire tonal range.

Unfortunately, while the Salazar, Hall et al., and Wells devices offer certain improvements and/or address certain deficiencies, none improve the sound and utility of a woodwind instrument via the inclusion of an internal baffle to generate a standing-wave on the reed, which results in an increased coupling between the reed and the instrument's air column. Therefore, there remains a need for an apparatus that provides a substantial degree of utility by facilitating the generation of a standing-wave on the reed, thereby providing an improvement in the response, tone, and power of the attached instrument. The apparatus, or elements thereof, should also be scalable to provide for use in a variety of musical applications, fabricated of materials that provide the durability/longevity required by the nature of its use, capable of being fitted to all existing woodwind instruments, and economical to manufacture, thereby providing for widespread use.

### SUMMARY OF THE INVENTION

It is, therefore, the primary object of the present invention to provide an improved mouthpiece for use in woodwind instruments.

It is another object of the present invention to provide an improved mouthpiece that generates a standing-wave on the reed, resulting in an improvement in the response, tone, and power of the attached instrument.

It is still another object of the present invention to provide an improved mouthpiece that increases the coupling between the reed and an instrument's air column.

It is another object of the present invention to provide an improved mouthpiece that is scalable to provide for use in a variety of applications.

Another object of the present invention to provide an improved mouthpiece that is fabricated of materials that provide the durability/longevity required by the nature of its use.

Yet another object of the present invention to provide an improved mouthpiece that may be fitted to all existing woodwind instruments.

Still another object of the present invention is to provide an improved mouthpiece that is economical to manufacture to provide for widespread use.

These and other objects are accomplished by a mouthpiece that generally comprises a body defined by a window opening at one end, a annular opening at another end, an internal tone chamber, and an internal bore, and a baffle positioned within the body at precisely the interface between the tone chamber and the bore immediately adjacent to the reed. The body is generally cylindrical with a tapered front section that is substantially flat on one side and a tapered rear section designed to attach to a woodwind instrument in a conventional manner. The baffle is situated within the body perpendicular to the longitudinal axis of the mouthpiece and serves to generate a standing-wave on the reed by reflecting the energy traveling along the surface of the reed. The presence of the standing-wave results in an increased coupling between the reed and the instrument's air column, thereby providing an improvement in the response, tone, and power of the attached instrument. Elements of the present invention are scalable to provide for use in a variety of musical applications. The present invention is fabricated of materials that provide the durability/longevity required by the nature of its use, capable of being fitted to all existing woodwind instruments, and economical to manufacture, thereby providing for widespread use.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a side, cross-sectional view of a mouthpiece 10 according to a preferred embodiment of the present invention.

FIG. 2 is a bottom, cross-sectional view of the mouthpiece 10 taken along line A-A of FIG. 1.

FIG. 3 is an end, cross-sectional view of the mouthpiece 10 taken along line B-B of FIG. 1.

FIG. 4 is a side, cross-sectional view of a mouthpiece 50 according to an alternative embodiment of the present invention.

FIG. 5 is a bottom, cross-sectional view of the mouthpiece 50 taken along line A-A of FIG. 4.

FIG. 6 is an end, cross-sectional view of the mouthpiece 50 taken along line B-B of FIG. 4.

### DETAILED DESCRIPTION OF THE PREFERRED EMBODIMENTS

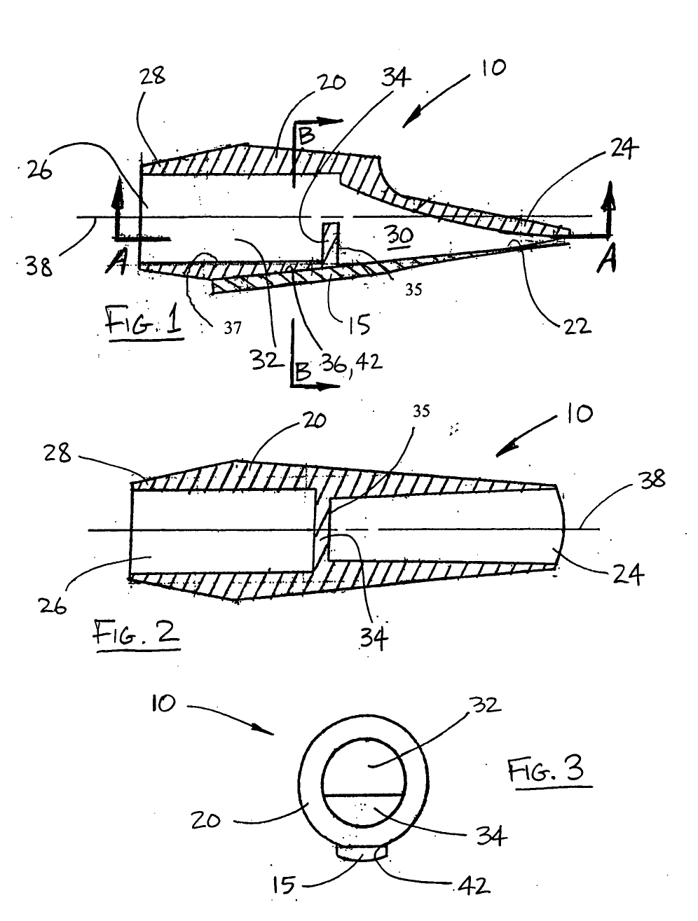

FIGS. 1-3 are, respectively, side, bottom, and end cross-sectional views of a mouthpiece 10 according to a preferred embodiment of the present invention. A reed 15 is shown attached to the mouthpiece 10, for illustrative purposes only, in FIGS. 1 and 3.

The mouthpiece 10 generally comprises molded or machined sidewalls that define a body 20 with a window opening 22 at a front end 24 leading to an internal tone chamber 30, and an annular opening 26 at a rear end 28 leading to an internal bore 32. In accordance with the present invention a baffle 34 is positioned within the body 20 such that the side 35 of baffle 34 (facing the chamber 30) has its plane in coincidence with the plane of the bottom 37 of the bore 32. The mouthpiece 10, inclusive of the body 20 and the baffle 34, may be a unitary component fabricated of hard rubber, metal, plastic, wood, or other appropriate materials, or it may be an assembly of two or more components joined by gluing, brazing, or other suitable means.

The body 20 is generally cylindrical with a tapered front section 24 that is substantially flat along one side 36 and houses the tone chamber 30, and a tapered rear section 28 designed to attach to a woodwind instrument in a conventional manner, which houses the bore 32. The flat underside 36 of the front portion 24 defines the aforementioned window opening 22 as well as an area surrounding the window opening 22. This flat external surface surrounding the window opening 22 and against which the reed 15 rests is the table 42. The tone chamber 30 is located within the front portion 24 and is in fluid communication with the window opening 22. A reed 15 extends over the window opening 22 and part of the table 42 of the mouthpiece 10, and is detachably attached to the mouthpiece 10 with a conventional ligature (not shown in the Figures), such as is commercially available from Rovner Products, P.O. Box 4116 Timonium Md. 21094. The baffle 34 is located within the body 20 and in the preferred embodiment has a front surface 35 that rises perpendicular to the longitudinal axis 38 of the mouthpiece 10 at the edge of window opening 22. The baffle 34 rises approximately ¼ to ½ the diameter of the tone chamber 30 at that point, as a matter of preference.

The operation of the mouthpiece 10, once appropriately attached to a woodwind instrument, is as follows. The baffle 34 is situated within the body perpendicular to the longitudinal axis 38 of the mouthpiece 10 and, therefore, acts to reflect the flow of energy traveling along the reed 15. The reflection serves to generate a standing-wave on the reed 15 as a user (i.e. musician) triggers a tone on the mouthpiece 10. The presence of the standing-wave results in an accentuation of the acoustic pressure against the reed 15, thus increasing the coupling between the reed 15 and the instrument's air column, thereby providing an improvement in the response, tone, and power of the attached instrument.

By experimentation, it has been found that locating the baffle top surface precisely in the same plane as the bottom 37 of the bore 32 improves the efficacy of the baffle 34. This improvement results from the unifying of the shock fronts that develop at each of the cross-sectional changes in area had the bore bottom 37 and the baffle surface 35 not been coincident. Shock front formation and the proper design treatment of shock fronts have not been addressed in the prior art. In addition to the improvement of baffle efficiency, the elimination of closely spaced shock fronts or internal mouthpiece geometries which contribute to unstable shock front positions have been found to greatly reduce “dry” or “coarse” tonal qualities.

The baffle 34 may be adapted for use in generic woodwind instrument mouthpieces 10 or in improved mouthpieces such as that disclosed in U.S. Pat. No. 5,018,425 issued to the present inventor. The height or size of the baffle 34 (i.e. the degree to which it reflects the energy traveling along the reed) may be determined empirically to optimize the response, power, and tonal response of different instruments, or to suit the personal taste or preference of a user.

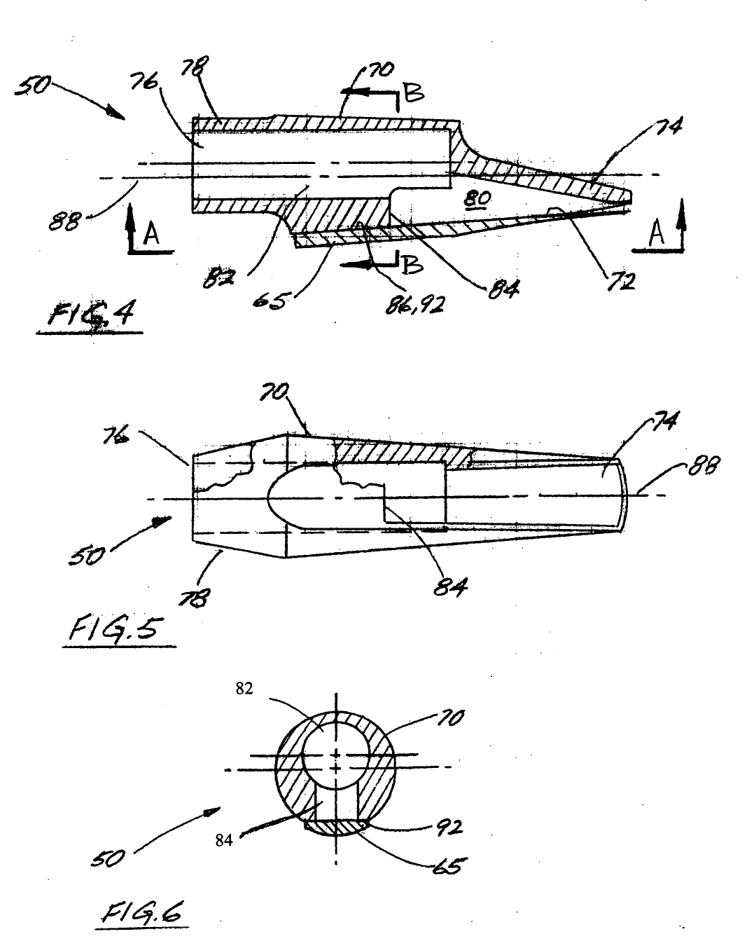

FIGS. 4-6 are, respectively, side, bottom, and end cross-sectional views of a mouthpiece 50 according to an alternative embodiment of the present invention. A reed 65 is shown attached to the mouthpiece 50, for illustrative purposes only, in FIGS. 4 and 6.

The mouthpiece 50 generally comprises a body 70 defined by a window opening 72 at a front end 74, a annular opening 76 at a rear end 78, an internal tone chamber 80, and an internal bore 82, and a baffle 84 positioned within the body 70 at precisely the interface between the tone chamber 80 and the bore 82. The mouthpiece 50, inclusive of the body 70 and the baffle 84, may be a unitary component fabricated of hard rubber, metal, plastic, wood, or other appropriate materials, or it may be an assembly of two or more components joined by gluing, brazing, or other suitable means.

The body 70 is generally cylindrical with a tapered front section 74 that is substantially flat along one side 86 and a tapered rear section 78 designed to attach to a woodwind instrument in a conventional manner. The baffle 84 is located within the body 70 perpendicular to the longitudinal axis 88 of the mouthpiece 50. The flat side 86 of the front portion 74 comprises the aforementioned window opening 72 and a table 92 (the flat external surface of the mouthpiece 50 surrounding the window opening 72 against which the reed 65 rests). The tone chamber 80 is located within the front portion 74 and is in fluid communication with the window opening 72. A reed 65 extends over the window opening 72 and part of the table 92 of the mouthpiece 50, and is detachably attached to the mouthpiece 50 with a ligature (not shown in the Figures). The longitudinal bore 82 is located within the rear portion 78 of the mouthpiece 50.

By offsetting the bore 82 toward the top of the body, a baffle 84 is effected at the interface between the tone chamber 80 and the bore 82. In a manner similar to the preferred embodiment of FIGS. 1-3, the baffle 84 of the alternative embodiment serves to reflect the energy traveling along the reed 65 to generate a standing wave on the reed 65. This increases the acoustic pressure on the reed 65, thereby improving the coupling between the reed 65 and the vibrating air column of the instrument. The coupling improves the response, tone, and power of the tonal system.

The baffle 84 may be adapted for use in generic woodwind instrument mouthpieces 50 or in improved mouthpieces such as that disclosed in U.S. Pat. No. 5,018,425 issued to the present inventor. The height or size of the baffle 84 (i.e. the degree to which it reflects the energy traveling along the reed) may be determined empirically to optimize the response, power, and tonal response of different instruments, or to suit the personal taste or preference of a user.

Elements of the present invention are scalable to provide for use in a variety of musical applications. The present invention is fabricated of materials that provide the durability/longevity required by the nature of its use, capable of being fitted to all existing woodwind instruments, and economical to manufacture, thereby providing for widespread use.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

1. A mouthpiece for a woodwind instrument, comprising:
a body comprising sidewalls that define a window at one end opening to an internal tone chamber, said tone chamber tapering to an internal bore;
a reed partially covering said bore window;
a baffle formed in said body at a position corresponding between the tone chamber and the internal bore and abutting said reed, to reflect energy traveling along said reed, and thereby generate a standing-wave, thereby adding tone to the mouthpiece.

2. The mouthpiece according to claim 1, wherein said baffle is positioned within said body perpendicular to a longitudinal axis of said internal bore.

3. The mouthpiece according to claim 1, wherein said baffle is integrally formed with the body as a unitary component.

4. The mouthpiece according to claim 1 wherein said baffle is separately formed from the body and is joined thereto by gluing or brazing.

5. The mouthpiece according to claim 1 wherein said body is fabricated of any one from among the group consisting of: hard rubber, metal, plastic, or wood.

6. The mouthpiece according to claim 1, wherein the baffle rises approximately ¼ to ½ a diameter of the tone chamber.

7. The mouthpiece according to claim 1, wherein the baffle has a front surface that rises perpendicular to a longitudinal axis of the bore at an edge of said window.

8. The mouthpiece according to claim 7, wherein the baffle has a top surface coplanar with an abutting inner sidewall of said bore.

9. The mouthpiece according to claim 1, wherein said bore is offset toward the top of said body.

10. In a mouthpiece for a woodwind instrument of a type having a body comprising sidewalls that define a window at one end opening to an internal tone chamber, said tone chamber tapering to an internal bore, and a reed partially covering said bore window:
a baffle positioned in said body between the tone chamber and the internal bore and abutting said reed, to reflect energy traveling along said reed, and thereby generate a standing-wave, thereby adding tone to the mouthpiece.

11. The baffle according to claim 10 positioned within said body perpendicular to a longitudinal axis of said internal bore.

12. The baffle according to claim 10 integrally formed with the body as a unitary component.

13. The baffle according to claim 10 separately formed from the body and joined thereto by gluing or brazing.

14. The baffle according to claim 10 fabricated of any one from among the group consisting of: hard rubber, metal, plastic, or wood.

15. The baffle according to claim 10 that rises approximately ¼ to ½ a diameter of the tone chamber.

16. The baffle according to claim 10 comprising a front surface that rises perpendicular to a longitudinal axis of the bore at an edge of said window.

17. The baffle according to claim 10 comprising a top surface coplanar with an abutting inner sidewall of said bore.

18. A mouthpiece for a woodwind instrument, comprising:
a substantially cylindrical body for attachment to a woodwind instrument in a conventional manner, said body comprising;
tapered first and second ends, said first end being substantially flat along one side;
a substantially rectangular opening in said flat side of said first end;
a substantially circular opening at said second end;
an internal tone chamber; and
an internal bore in fluid communication with said tone chamber; and
a baffle located precisely at an interface between said tone chamber and said bore immediately adjacent a reed.

19. The mouthpiece according to claim 18, wherein the baffle has a front surface that rises perpendicular to a longitudinal axis of the bore at an edge of said window.

20. The mouthpiece according to claim 19, wherein the baffle has a top surface coplanar with an abutting inner sidewall of said bore.
